(19) United States
(12) Patent Application Publication
(10) Pub. No.: US 2001/0039578 A1
(43) Pub. Date: Nov. 8, 2001

(54) Content distribution system

(76) Inventors: Hiroshi Tokumaru, Kyoto-city (JP); Kouichi Ozawa, Kyoto-city (JP)

Correspondence Address: SHAW PITTMAN, 2300 N STREET, N.W., WASHINGTON, DC, 20037-1128, US

(21) Appl. No.: 09/821,029

(22) Filed: Mar. 30, 2001

(30) Foreign Application Priority Data
Mar. 31, 2000 (JP) 2000-097541

(51) Int. Cl. G06F 15/173; G06F 15/16

(52) U.S. Cl. 709/223; 709/203

(57) ABSTRACT

A language conversion system, capable of creating and changing content easily, is provided. In a content server 30, contents created by data written in the basic language, which can easily be converted into other languages, are stored. The content server 30 identifies the type of a terminal device accessing thereto. Content requested by the terminal device is converted into the content written in a language appropriate to the type of the terminal device on a real time basis and then being transmitted thereto when the terminal device is able to control of transition among contents. When the terminal device is not a controllable one for transition, information on session is generated and display of the content on the terminal device is controlled by the server 30.

### CROSS REFERENCE TO RELATED APPLICATIONS

All the contents disclosed in Japanese Patent Application No. 2000-97541 (filed on Mar. 31, 2000), including specification, claims, drawings and abstract and summary are incorporated herein by reference in its entirety.

### FIELD OF THE INVENTION

This invention relates to a content distribution server, which distributes content to terminal devices.

### BACKGROUND OF THE INVENTION

FIG. 1 shows a conventional content distribution system. In the system, an i-mode (trademark) terminal 4 and a Personal Handy phone System (hereinafter referred to as PHS) terminal 8 may access to a server 16 for i-mode and a server 20 for PHS respectively via the Internet 12. i-mode is mobile Internet access services in Japan, by which contents on the Internet can be viewed using a browser equipped in its mobile phones as terminals.

In order to retrieve content, the i-mode terminal 14 need to access to the i-mode server 16. To do that, the PHS terminal 8 have to access to the PHS server 20 as well. Content can not be retrieved (not displayed properly) even an access from the i-mode terminal 4 is made to the PHS server 20.

Both an i-mode terminal and a PHS terminal is clearly differ from each other in that the former employs a browser capable of controlling link among contents is employed unlike to the PHS terminal which does not use such browser. In response to such difference, the method describing contents used for both the terminals is totally different from each other.

Thus, users of such terminals need to change one of the severs to be accessed depending on the type of the terminal even when all the users try to access to the identical content. With the conventional system, another problem, such that desired content can not view properly when the content is prepared solely for a terminal(s) having different display restrictions, is also observed.

Suppliers of content, in contrast, need to prepare contents written for all kinds of terminals and they have to provide servers for storing these contents in order to make the contents to be viewed by many users. It is, therefore, creation of the contents, maintenance, and updating thereof require a lot of work to the suppliers.

It is an object of the present invention to provide a server for distributing content, by which suitable content for each of terminals is distributed thereto without providing servers for each of the terminals corresponding to display restrictions of the terminals.

### SUMMARY OF THE INVENTION

(1) In accordance with characteristics of the present invention, there is provided a content server receiving an access by different types of terminal devices comprising:

content storage means, storing content;

terminal identifying means, identifying whether or not the terminal device accessing thereto is controllable for transition from content to other content in accordance with description in the content received by the accessing terminal device;

management information generating means, generating management information in accordance with content read out from the content storage means when the terminal identifying means judges that the accessing terminal device is not controllable for the transition; and

transition control means, controlling transition of content to be transmitted to the terminal device according to the management information in response to a request from the terminal device.

As a consequence, contents having identical descriptions to that for terminal device controllable for the transition, can be also used for terminal devices uncontrollable therefor. In this way, contents commonly created can be distributed to a large number of terminal devices so that creation of contents and modification thereof is facilitated.

(4) In accordance with characteristics of the present invention, there is provided a content server in which new management information is generated and previous information is discarded whenever the terminal device requires new content.

Just slight modification on content can do even when information on link among contents is varied because the management information is generated on a temporary basis whenever the terminal device requires new content.

(5) In accordance with characteristics of the present invention, there is provided a content server in which the management information generating means generates non-response permissible information, for terminating communication between the server and the terminal device when no reply is received from the terminal device, as a part of the management information.

Session can be ended in proper procedures even when power of the terminal device is turned off in the middle of the session and other similar reasons.

(6) In accordance with characteristics of the present invention, there is provided a content server in which the management information generating means generates a session ID as a part of the management information whenever the terminal device accesses thereto.

As a consequence, sessions performed by multiple terminal devices accessing simultaneously to the server can be managed adequately.

(7) In accordance with characteristics of the present invention, there is provided a content server in which terminal identifying means identifies whether or not the terminal device accessing thereto is controllable for transition by identifying type of the terminal device.

In this way, controllability for transition of the terminal device can be identified by just obtaining type of the terminal device.

(8) In accordance with characteristics of the present invention, there is provided a content server in which the terminal identifying means performs the identification of controllability in accordance with a header of Hyper Text Transfer Protocol (HTTP) sent from the terminal device.

Thus, the type of the terminal device can accurately be identified because the HTTP header indicates the protocol used by the terminal device.

(9) In accordance with characteristics of the present invention, there is provided a content server in which the terminal identifying means performs the identification of controllability in accordance with an IP address sent from the terminal device.

Type of the terminal devices can be identified accurately because the way of assigning IP addresses is unique among communication common carriers that define the type of the terminal devices.

(10) In accordance with characteristics of the present invention, there is provided a content server in which the terminal identifying means identifies a size of content which can be stored temporarily at the terminal device for its display as well, and wherein the management information generating means divides the content in accordance with its size.

Thus, appropriate content can be distributed to each of the terminal devices by just preparing common contents regardless of the display restrictions of the terminal devices.

(14) In accordance with characteristics of the present invention, there is provided a content server which temporary generates information for performing transition from content to other content as management information in accordance with description in content received thereby which is written in a self-descriptive language,

and wherein the content server controls transition of content to be transmitted to a terminal device according to the generated management information in response to a request from the terminal device.

As a consequence, contents having identical descriptions to that for terminal device controllable for the transition, can be also used for terminal devices uncontrollable therefor. In this way, contents commonly created can be distributed to a large number of terminal devices so that creation of contents and modification thereof is facilitated.

(17) In accordance with characteristics of the present invention, there is provided a content server in which the content server divides the content in accordance with a size of content which can be stored temporarily at the terminal device for its display.

Thus, appropriate content can be distributed to each of the terminal devices by just preparing common contents regardless of the display restrictions of the terminal devices.

(18) In accordance with characteristics of the present invention, there is provided a method of distributing content to different types of terminal devices, the method comprising the steps of:

storing the content;

identifying whether or not the terminal device requesting content is controllable for transition from content to other content in accordance with description in the content received by the terminal device;

transmitting the requested content with information for controlling the transition contained therein when the requested content is distributed to the terminal controllable for the transition; and

managing transition from content to other content at an end of distributing the content when the requested content is distributed to the terminal uncontrollable for the transition.

As a consequence, contents having identical descriptions to that for terminal device controllable for the transition, can be also used for terminal devices uncontrollable therefor. In this way, contents commonly created can be distributed to a large number of terminal devices so that creation of contents and modification thereof is facilitated.

The term “terminal identifying means” refers to at least means identifying whether or not the terminal device accessing thereto is controllable for transition from content to other content in accordance with description in the content received by the accessing terminal device. It also forms any means identifying controllability for transition of the terminal devices with indirect method by acquiring the type of the terminal device, and means receiving information on controllability therefor send from the terminal devices (for example, means receiving information about whether or not the terminal device is controllable for transition).

The term “output restrictions” refers to restrictions imposed on the output of the content. It also forms a concept including restrictions on display that of audio output, that of printing, writing of data and so on.

The term “management information” refers to information for managing transition of content display at terminal devices, the term corresponds to the term session information in embodiment described herein.

Other objects and features of the present invention will be more apparent to those skilled in the art on consideration of the accompanying drawings and following specification, in which are disclosed several exemplary embodiments of the present invention. It should be understood that variations, modifications and elimination of parts might be made therein as fall within the scope of the appended claims without departing from the spirit of the invention.

### BRIEF DESCRIPTION OF THE DRAWINGS

FIG. 1 is a diagram of a conventional content distribution system;

FIG. 2a is a diagram showing an example of a content distribution system using a content server according to the present invention;

FIG. 2b is a block diagram showing an example of the content distribution server according to the present invention;

FIG. 3 is a diagram showing the overall structure of basic language data;

FIG. 4 is a diagram showing the structure of the basic language data;

FIG. 5 is a diagram showing the structure of tags in the basic language data;

FIG. 6 is a diagram showing an example of the body of the basic language;

FIG. 7 is a diagram showing an example of a style sheet of the basic language;

FIG. 8 is a diagram showing an example of the body of the basic language;

FIG. 9 is a flowchart of the processes performed by a content distribution server for distributing content;

FIG. 10 is a flowchart of a program for identifying the type of terminals;

FIG. 11a is a flowchart of a program for generating information on session and for controlling transition of web pages;

FIG. 11b is another flowchart of a program for generating information on session and for controlling transition of web pages;

FIGS. 11c, 11d are views showing session information being generated as a result of performing division of content;

FIG. 12 is a view showing how to identify a session ID;

FIG. 13 is a view showing content thus converted in its format;

FIG. 14 is an example of session information;

FIG. 15 is an image displayed on a PHS terminal device;

FIG. 16 is a view illustrating a result of conversion in format;

FIG. 17 is a view showing an example of information on sessions;

FIG. 18 is another image displayed on the display of a PHS terminal device;

FIG. 19 is a flowchart of a program for converting a language into another language;

FIG. 20 is a diagram showing the structure of the basic language data;

FIG. 21 is a view showing the tree structure of the basic language data;

FIG. 22 is a view showing the tree structure of the basic language data;

FIG. 23 is a view showing data converted into the tree structure;

FIG. 24 is a view showing data converted into the tree structure;

FIG. 25 is a flowchart of a program for converting basic language data into HTML (Hyper Text Markup Language) data;

FIG. 26 is a view showing the converted HTML data;

FIG. 27 is a diagram showing an image displayed on the screen with the HTML data shown in FIG. 26;

FIGS. 28a, 28b are flowcharts of a program for converting basic language data into HDML (Handheld Device Markup Language) data;

FIG. 29 is a view showing the HDML data thus converted;

FIG. 30 is a diagram showing an image displayed on the screen with the HDML data depicted in FIG. 29

FIG. 31 a view showing another divided content; and

FIG. 32 is a view showing another divided content.

### DETAILED DESCRIPTION OF THE INVENTION

1. Content Distribution System

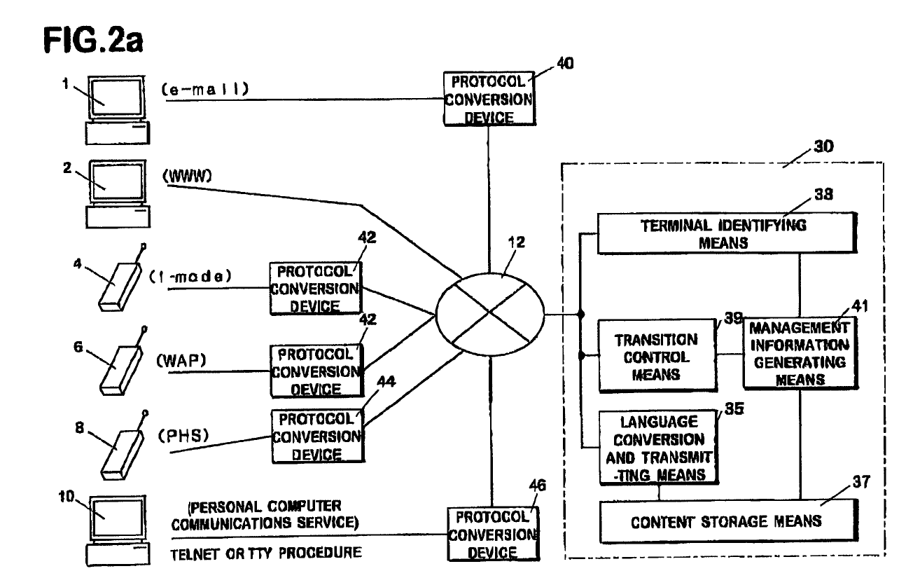

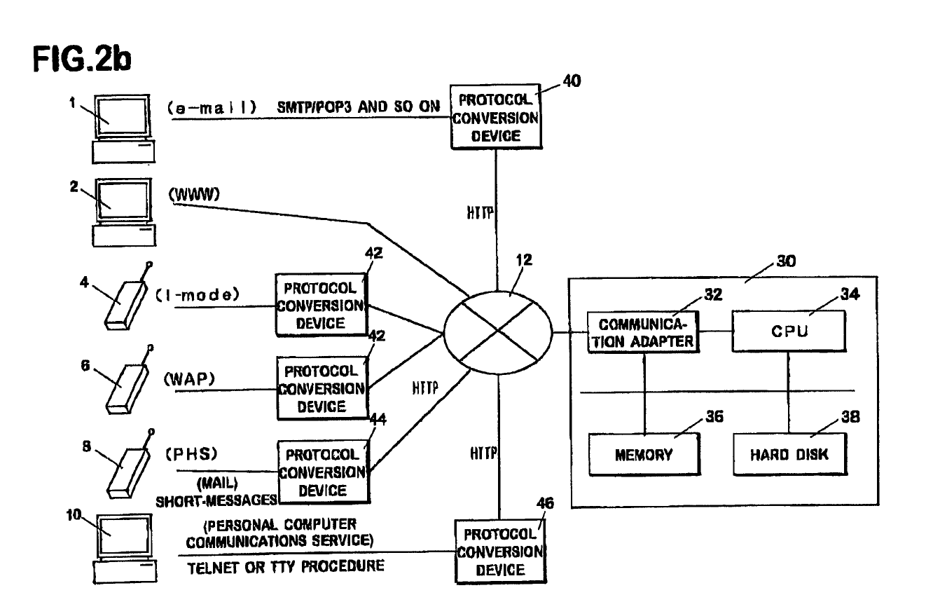

An example of a content distribution system according to the present invention is depicted in FIG. 2a. Connected to the Internet 12 is a server 30 for distributing content (hereinafter referred to as content server). Also, terminal devices 2, 4, 6, 8, and 10 each different in type are connectable to the Internet 12.

The personal computer (hereinafter referred to as PC) 1 is accessible to the content server 30 via a protocol converting device 40 in an electric-mail format (that is, in both SMTP/POP3). The PC 2 is also accessible to the content server 30 using a browser software (that is, in http protocol). Further, mobile phones 4, 6, and 8 are respectively accessible to the content server 30 via protocol converting devices 42 and 44 (see FIG. 2b) in the forms of “i-mode cellular phone system”, “WAP”, and “electric mail”. The PC 10 is accessible to the content server 30 via a protocol converting device 46.

This embodiment discloses an approach to make contents capable of being utilized by terminal devices (a PC 2 browsing with WWW, an i-mode terminal 4, a WAP terminal 6) which can control transition among contents by itself and other terminal devices (a PC 1 equips just e-mail, PHS terminal 8, and a terminal 10 for personal computer communications service) which can not control transition among contents by itself. Languages used for display are differ from one another even in the controllable terminals (a PC 2 browsing with WWW, an i-mode terminal 4, a WAP terminal 6). This embodiment realizes standardization of contents written in the basic language, which can absorb such difference in language.

The content server 30 comprises terminal identifying means 33, transition control means 39, management information generating means 41, language conversion and transmission means 35 and content storage means 37. Contents written in the basic language is stored in the content storage means 37.

The terminal identifying means 33 identifies type of the terminal device accessing to the server. The management information generating means 41 reads out content written in the basic language from the content storage means 37 when the accessing terminal is judged as a uncontrollable terminal for transition.

The management information generating means 41 generates information for controlling transition among contents in accordance with the content thus read out on a real time basis. The transition control means 39 transmits the content to the accessing terminal and determines subsequent content to be transmitted to the terminal according to the generated information.

The management information generating means 41, then reads out the subsequent content from the storage means 37 and generates new information for controlling transition. The transition control means 39 transmits the subsequent content to the terminal device. Thus, communications between the server and the terminal device is carried out.

When a terminal device detected by the terminal identifying means 33 is the terminal which can control transition among contents by itself, the language conversion and transmission means 35 converts content written in the basic language into one written in a display language used by a terminal device depending on the type of the terminal device thus identified. The conversion means 35 sends the converted content to the terminal after the conversion.

FIG. 2b is a diagram showing the overall system and a block diagram of the hardware for the content server 30. The content server 30 comprises a communication adapter 32 for connecting to the Internet 12, a CPU 34, a memory 36, and a hard disk 38. Stored in the hard disk 38 are the operating system (such as UNIX etc.), a program for identifying terminals, a program for converting language, a program for controlling transition among contents and for generating management information. In addition, content written in the basic language is stored therein. The terminal type identification program performs a process in which type of the terminal accessing is identified by collaborating with the operating system. Also, the language conversion program carries out a process in which the basic language data is converted into the data written in a language appropriate to the display language used with each of the terminals in association with the operating system. The controlling transition and generating management information program is a program in association with the operating system for performing processing in which data format of content is adjusted so as to match with display restrictions of each terminal device.

2. Structure of Basic Language Data

(1) Overall Stricture

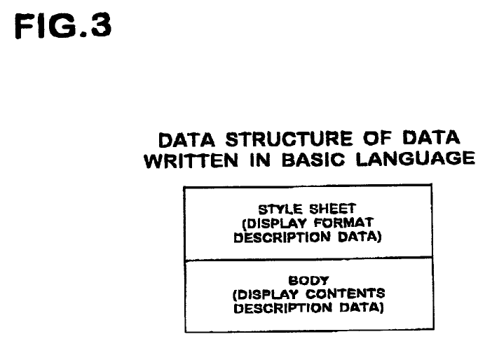

In this embodiment, data of the content stored in the hard disk 38 is written in the basic language. FIG. 3 shows the structure of such data. The basic language data comprises a style sheet (display format description data) describing a display format thereof and the body representing the contents of displays (display contents description data). The style sheet is a part describing color for display, size of characters, display formats and so on. The body is a part representing a text describing its contents. The style sheet, however, is provided to the data optionally. It is meant that the data will be displayed in the standard format when none of the style sheet is provided.

The use of such basic language ease the generation of management information. This also facilitates a processing which converts content written in the basic language into that written in a display language for a terminal device. The management information, however, may also be generated in accordance with content written in the basic language previously stored into the content storage means 37.

In this embodiment, the body of the data is common regardless of the display language after conversion in language, but the style sheet is unique to the display language after the conversion. Thus, it is necessary to provide a style sheet for data each written in HTML and HDML respectively when the display format of these data other than the standard format is desired.

Hence, when a style sheet just for the HTML data is provided therefor, the standard display format is employed on the HDML data during conversion. In other embodiment, a common style sheet may be used regardless of the display language used after conversion.

(2) Body of Data

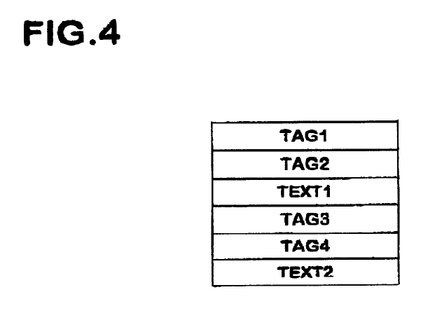

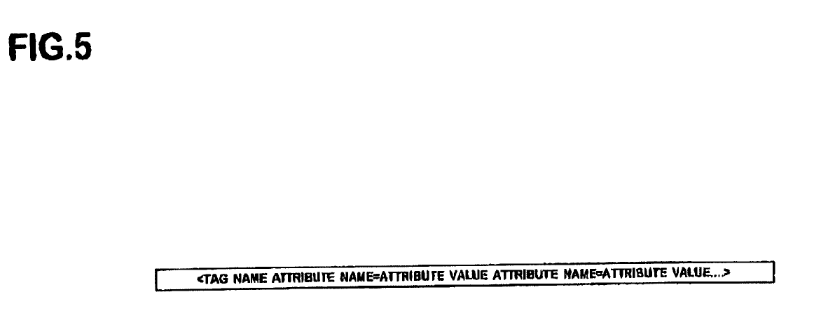

The descriptive structure of a body is shown in FIG. 4. The body comprises tags (parts surrounded by “<” and “>”) and texts (parts other than the tags). The tags, as shown in FIG. 5, start with “<”, then the name of the tags (English characters; essential) and both attributes follow thereafter, and end with “>”. The attributes includes these, the name of the attributes (English characters), “=”, and attribute values (arbitrary characters). Attributes are optionally provided to the data, the data can do without attributes.

Tags start with “<A” (hereinafter referred to as A-tag) and tags start with “<P” (hereinafter referred to as P-tag) accompany subsequent texts, and end with “</A>” and “/P>” respectively. Conversely, in basic language data, texts only appear right after an A-tag or a P-tag.

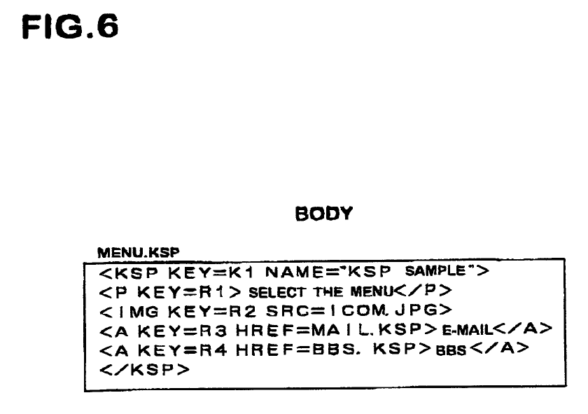

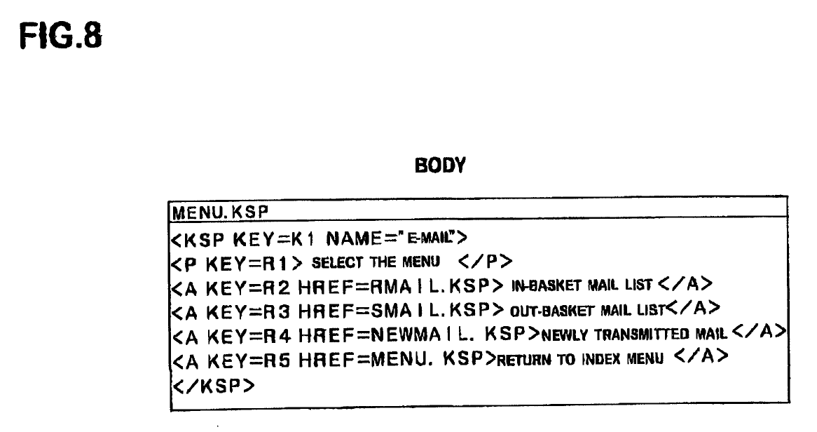

FIG. 6 is a diagram showing an example of the body of basic language data. In this example, a total of three (3) texts such as “select the menu” “E-mail”, and “BBS” are included. On the third line, a file name of image data to be displayed is described after “SRC=”. Link destinations are written after “HREF=” on the fourth and the fifth line. For example, it is apparent from the description on the fourth line that the description is linked to “MAIL.KSP” shown in FIG. 8.

(3) Style Sheet

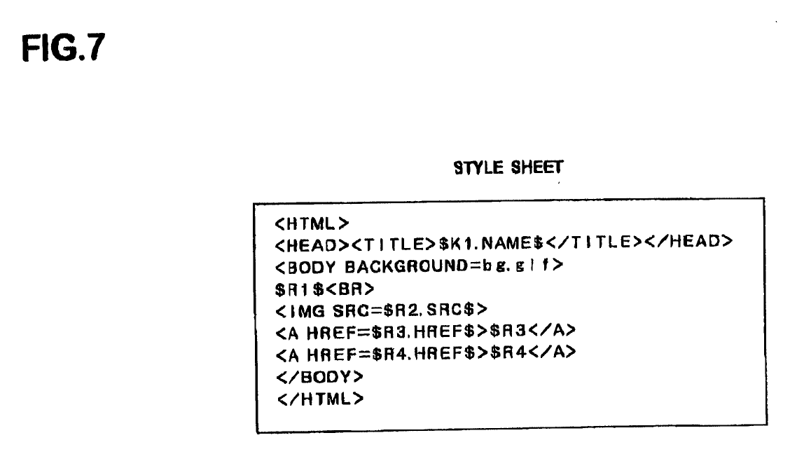

FIG. 7 is a diagram showing an example of a style sheet for HTML corresponding to the body shown in FIG. 6. The description “K1. NAME” located between “$”s on the second line shows that the description on this line indicates a display format of which one of the lines in FIG. 6. The description “K1” shows the name of the tag, so that the first line shown in FIG. 6 corresponds to the description. Interpretation of the style sheet will be described later.

3. Processing Performed by the Content Server 30

(1) Overall Processing

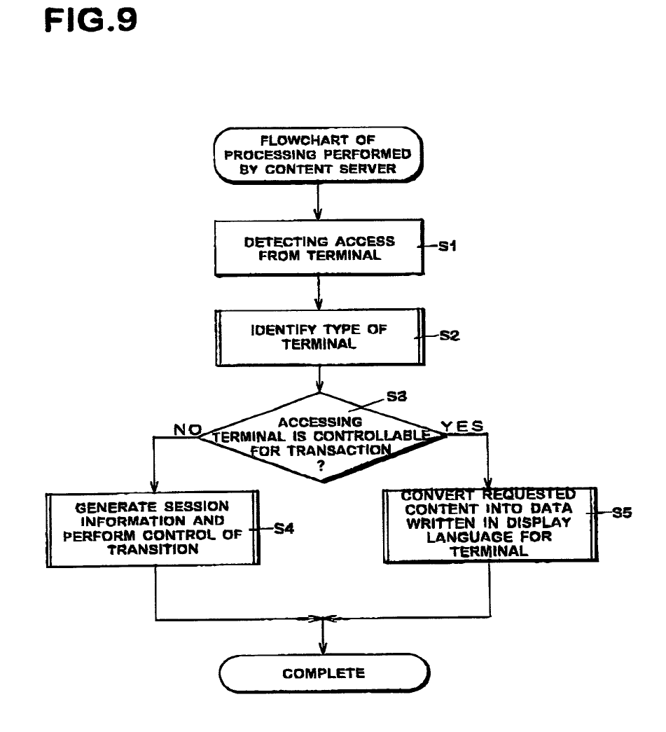

FIG. 9 is a flowchart of the processes performed by the content server 30. When an access from one of the terminals is detected (step S1), the content server 30 identifies the type of the accessing terminal (step S2). Another determination whether or not the accessing terminal is controllable for transition, is made depending on the type of the terminal detected (step S3).

When the terminal device is not a controllable one for transition, control of transition among contents is performed based on information about session (hereinafter referred to as session information) which is generated in accordance with the content being requested (step S4).

In the contrary, when the terminal device is a controllable one for transition, the requested content written in the basic language is converted into data written in the display language for the terminal, and the converted content is transmitted to the terminal (step S5).

As described above, content can be provided appropriately to any terminals regardless of its type either in controllable one or not by just preparing in the content server 30 contents written in the basic language. Furthermore, the server can send back data in a format appropriate to the terminal in response to a request from any one of the terminal devices.

(2) A Program for Identifying the Type of Terminals (step S2 in FIG. 9)

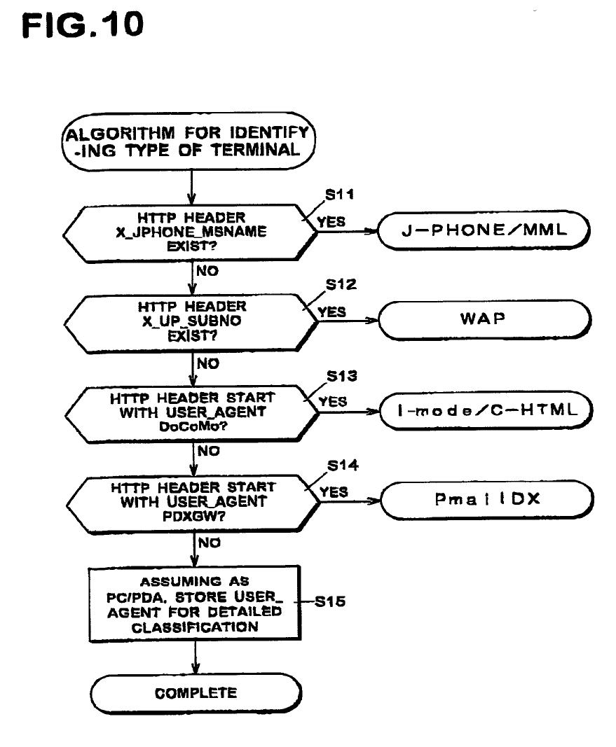

FIG. 10 is a flowchart of a program for identifying the type of terminals. When a terminal makes an access to the server 30, an HTTP header is sent thereto from the terminal. The server 30 identifies that the terminal uses HTML when “X_JPHONEMSNAME” is described in the HTTP header (step S11). When “X_UP_SUBNO2” is described in the header, the server judges that a language for the WAP is used for the terminal (step S12). The server 30 judges that terminal uses C-HTML (Compact HTML) when the description of “USER_AGENT” starts with “DoCoMo” (step S13). When the description of “USER_AGENT” starts with “PDXGW”, the server 30 judges that the terminal uses a language for PmailDX (trademark) (step S14).

When none of above judgements are made, the server 30 judges that the terminal accessing thereto is a PC (step S15). Furthermore, the server 30 judges which one of communication methods such as personal computer communication services, e-mail, HTML, is used in accordance with the description of “USER_AGENT”. The result of the judgement is stored in the memory 36 (see FIG. 2b).

As a result of the above judgements, terminals using: MML (Mobile Markup Language), language for WAP, C-HTML (compacted HyperText Markup Language), HTML, can be identified as controllable ones for transition. In the contrary, terminals using: a language for PmailDX (trademark), personal computer communications service, and an electric mail, can be identified as uncontrollable ones for transition.

(3) Program for Generating Information on Sessions and for Controlling Transition (step S4 of FIG. 9).

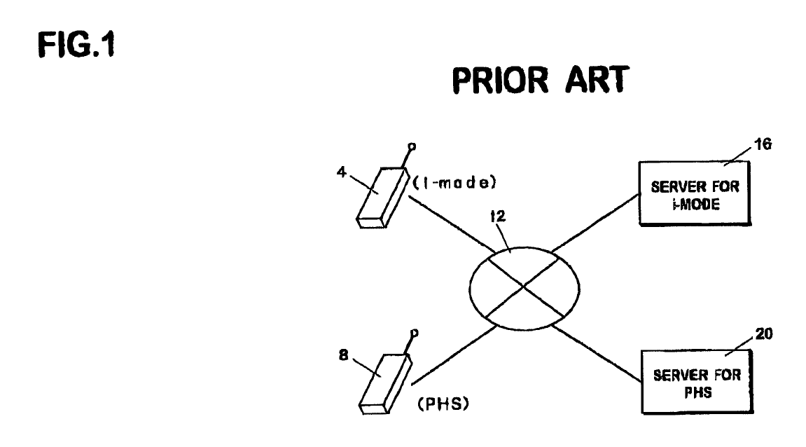

Subsequently, FIG. 1 la shows a series of processing for generating session information and controlling transition. The processing will be performed when an access is made by the PHS terminal 8 because the accessing terminal is identified as a terminal not controllable. The details of the processing is described assuming that “MENU KSP” shown in FIG. 8 is provided by a terminal device.

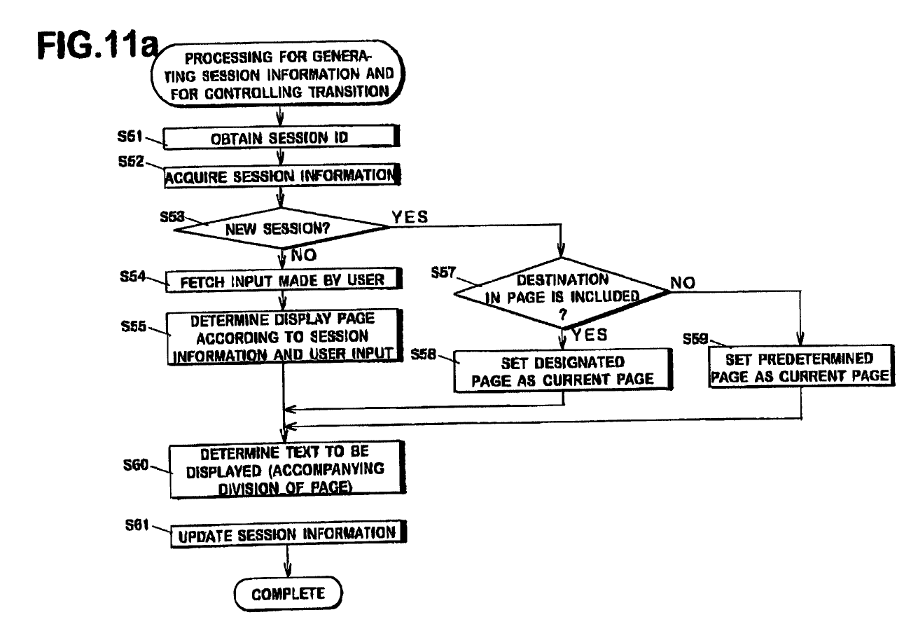

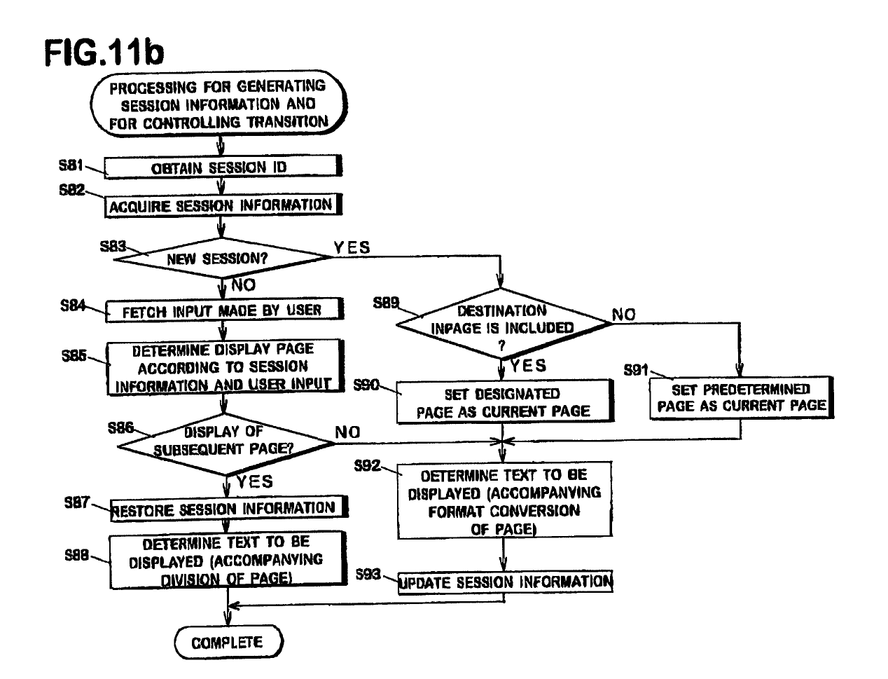

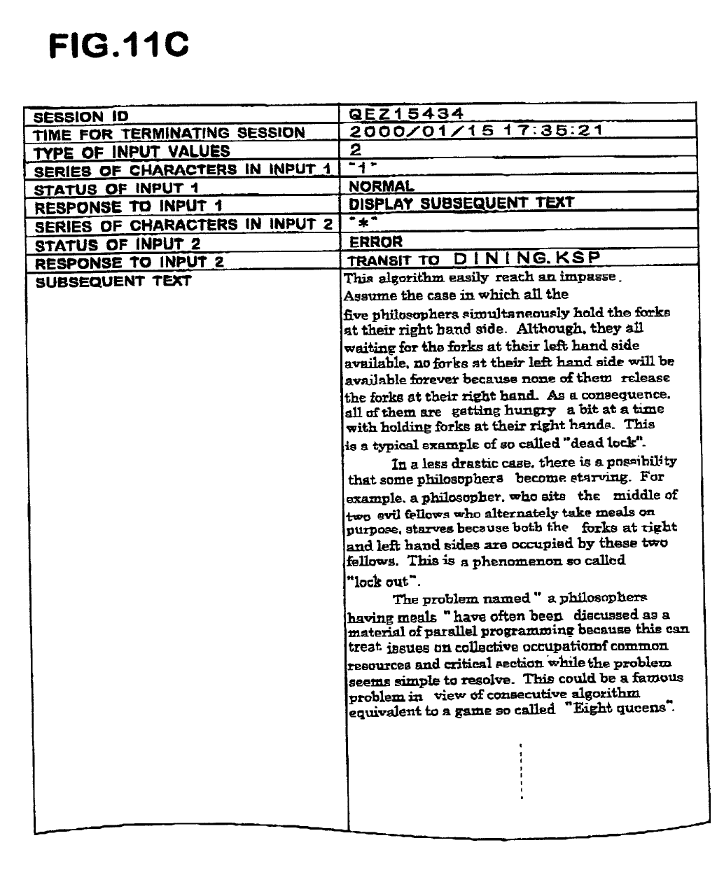

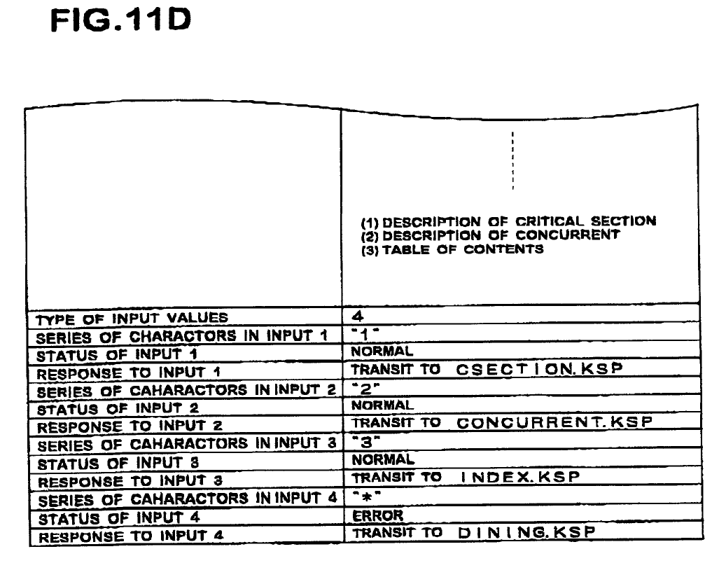

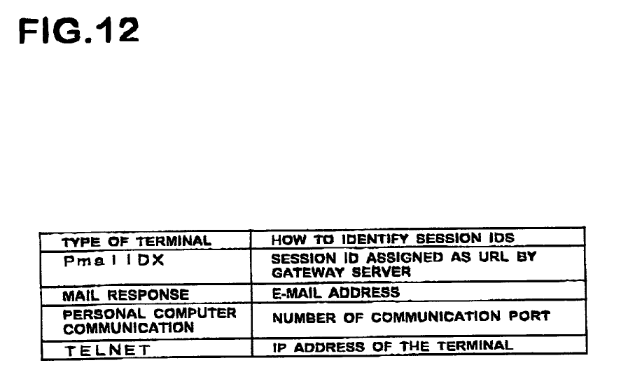

Initially, a session ID is obtained at step S51 of FIG. 11a. “a session ID” is meant to refer to an identifier virtually assigned to a terminal which is under access to a content server. In this embodiment, a session ID is obtained in a way depicted in FIG. 12.

Subsequently, session information identified by the session ID is acquired from the memory 36 (step S52 of FIG. 11a). No session information corresponding to the session ID is found when the session is newly initiated. In that case, the step proceeds to step S57.

At step S57, another judgement in which designation in page is included in a request from the terminal, is made. In this example, a specific page such as “MENU.KSP” is required so that the name of the designated page is set a position of the current page (step S58 of FIG. 11a). When no page is designated, a predetermined page (such as INDEX.KSP) is set a position of the current page (step S59 of FIG. 11a).

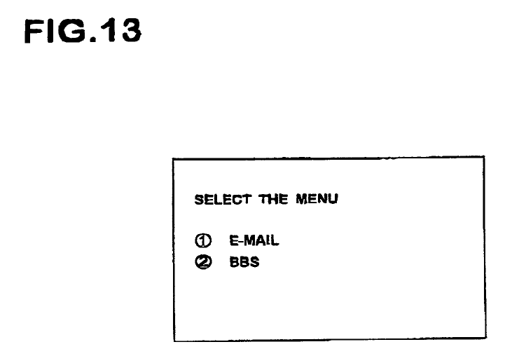

Subsequently, the contents of the designated page are read out from the hard disk 38 and are converted into a format appropriate to the terminal, and then the converted content is transmitted to the terminal (step S60 of FIG. 11a). For example, FIG. 13 shows a result of the conversion for the inquiry shown in FIG. 6.

The data displayed in FIG. 13 is meant that the display shown therein transits respectively to a display for “e-mail” and that for “bulletin board” when respective input of numeral “1” and numeral “2” is carried out at the terminal for a requirement in input “Select the menu”.

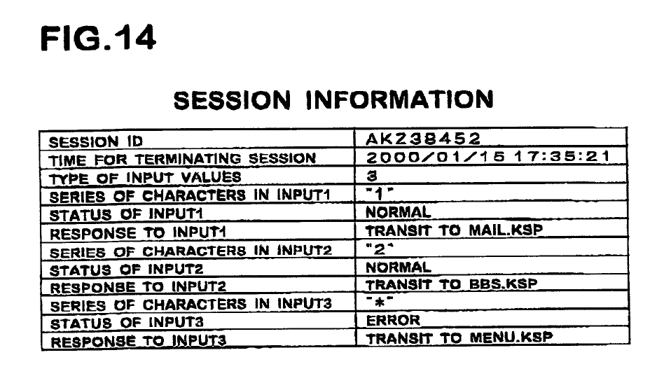

Subsequently, session information that is necessary to perform transition control at the server is generated and stored in the memory 36 (step S61 of FIG. 11a). FIG. 14 shows session information that is generated in accordance with the content shown in FIG. 6. “session ID” in the figure is the ID assigned according to the method of FIG. 12. “time for terminating session” is the time at which session is terminated by force, and it is set for preparing a case in which the network is disconnected without termination process and so on. The time for terminating session is set at a value, which add a predetermined period (e.g. 30 minutes) to the current time. “type of input values” shows the type of data capable of being input on pages currently transmitting (the pages displayed on the terminal device). The value of which is “3” in FIG. 14.

Characters, status and response, to each of inputs are stored in the session information. For example, “1” shows characters for input 1, and “normal” and “transit to MAIL.KSP” respectively representing status and response for that input. Characters for input 3 is “*”, and that is a wild card showing “any other characters”. Such wild card corresponds to characters except for both input 1 and input 2 (“1” and “2”). The status of such input is in “error” and shows “transit to MAIL.KSP” is carried out with a display of error.

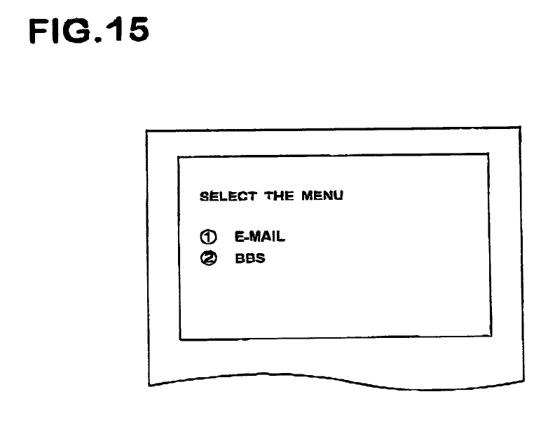

As a result of carrying out such operation, a screen image depicted in FIG. 15 is displayed on the PHS terminal 8.

The process, which will be performed when “1” is input to the PHS terminal 8 under the displayed screen image, will be described hereunder. In this case, the process also proceeds to step S51 of FIG. 11a through steps S1, S2 and S3 of FIG. 9. The process further proceeds to step S54 of FIG. 11a because it is judged that session information (FIG. 14) having a session ID obtained at step S51 exists. At step S54, the character “1” input through the terminal is fetched.

The content to be displayed subsequently is determined by referring the session information of FIG. 14 in accordance with the input “1” by the user (step S55 of FIG. 11a). Transition to data represented by “response to input 1” “MAIL.KSP” which correspond to “characters of input 1” “1” in the session information is carried out. In other words, data represented by MAIL.KSP (see FIG. 8) is read out from the hard disk 38 as the current page.

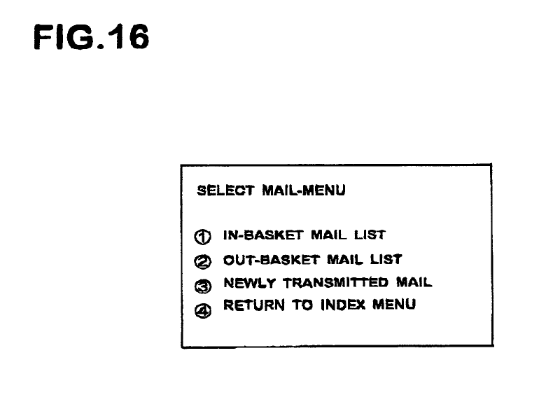

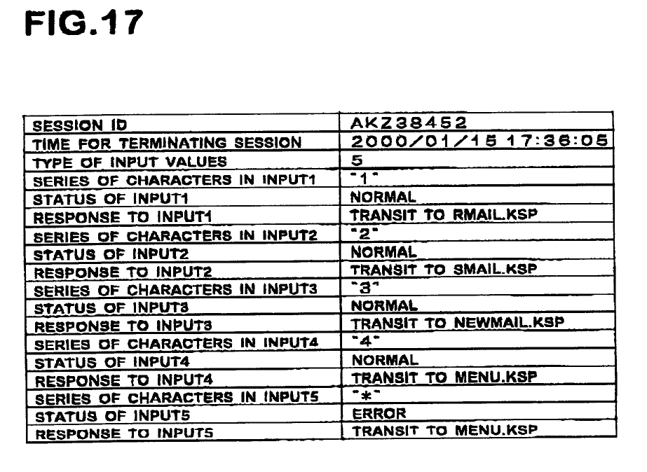

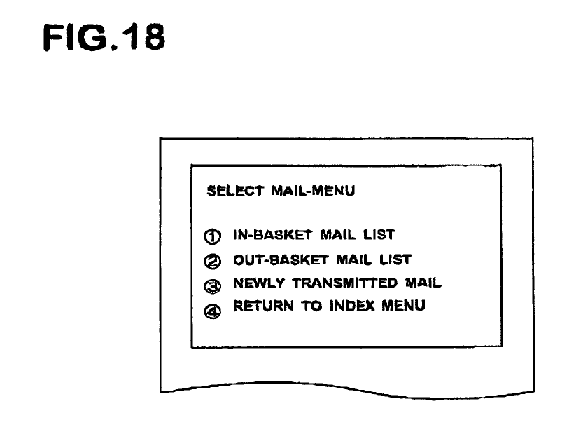

Conversion in format of the data MAIL.KSP thus read out is performed (step S60 in FIG. 11a). FIG. 16 shows the result of the conversion. Following the conversion, new session information depicted in FIG. 17 is generated and stored in the memory 36. The previous session information is discarded. A screen image shown in FIG. 18 is displayed on the terminal device as a result of carrying out steps described above.

The capacity of each terminal for storing content on a temporary basis differs depending on the type of a terminal. In order to achieve standardization of contents in consideration of display restrictions of such terminal, it is necessary to divide content to be transmitted depending on the type of the terminal. In such a case, session information containing all the divided contents is generated. FIGS. 11c, 11d show an example of such session information.

FIG. 11b is a flowchart illustrating process of such division of contents. At step S86, a judgement whether or not the one being displayed is the display of a divided subsequent page(s) (step S86 of FIG. 11b). When the display is not a subsequent page, similar steps to the steps shown in FIG. 11a will be performed. When the display is a subsequent page, the step proceeds to step S87 and the session information is kept without disposing, then the divided page(s) is transmitted (step S88 of FIG. 11b).

(4) A Program for Converting a Language into Another Language (step S5 of FIG. 9)

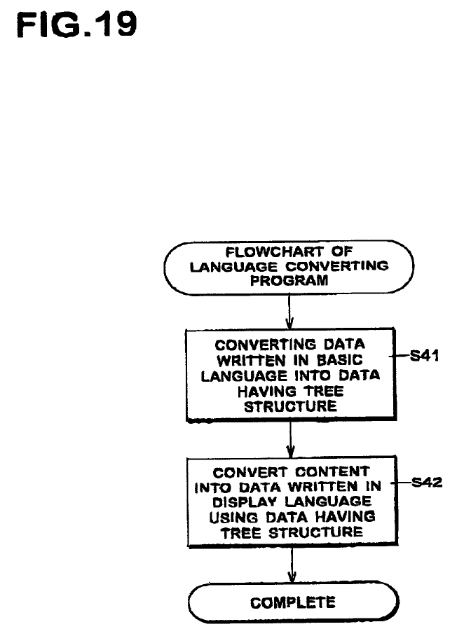

Subsequently, processing, performed when a terminal accessing is controllable for transition, will be described hereunder. In such a case, the process proceeds to step S5 from step S3. A program shown in FIG. 19 for converting a language into another language is performed at step 5. At the step, processing for converting content written in the basic language into data written in the display language for the terminal is carried out.

At step S41 of FIG. 19, data of the content written in the basic language is converted into data having a tree structure. Subsequently, the content is converted into data written in a desired display language in accordance with the tree structure data (step S42 of FIG. 19).

The conversion processing, in which the PC 2 using a browser software makes a request for viewing content written in the basic language, which includes both the style sheet shown in FIG. 7 and the body depicted in FIG. 6, will be described. In this case, the display language used for the terminal can be judged as HTML (see FIG. 10). Hence, the language used for that content need to be converted into HTML eventually.

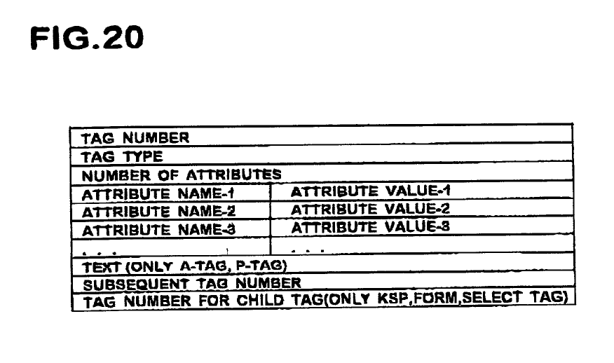

The processing for converting the basic language data into data having a tree structure (step S41 of FIG. 19) will be described. In order to perform such processing, tags on each line of the body depicted in FIG. 6 are analyzed into the data structure shown in FIG. 20. Subsequent tag number and tag number for child-tags will be described below.

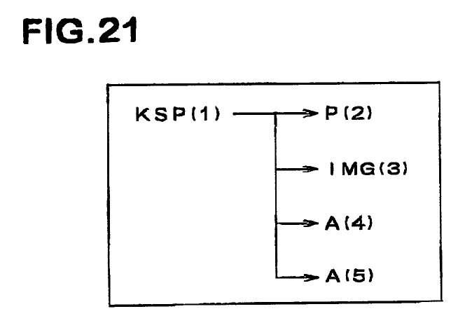

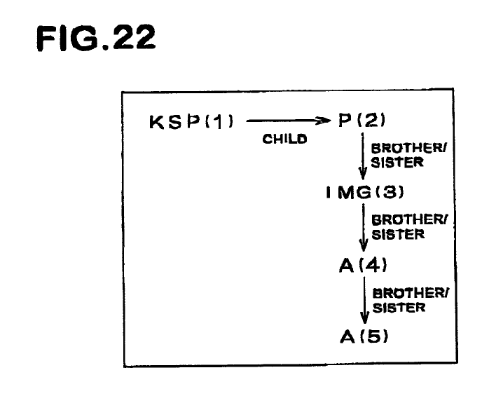

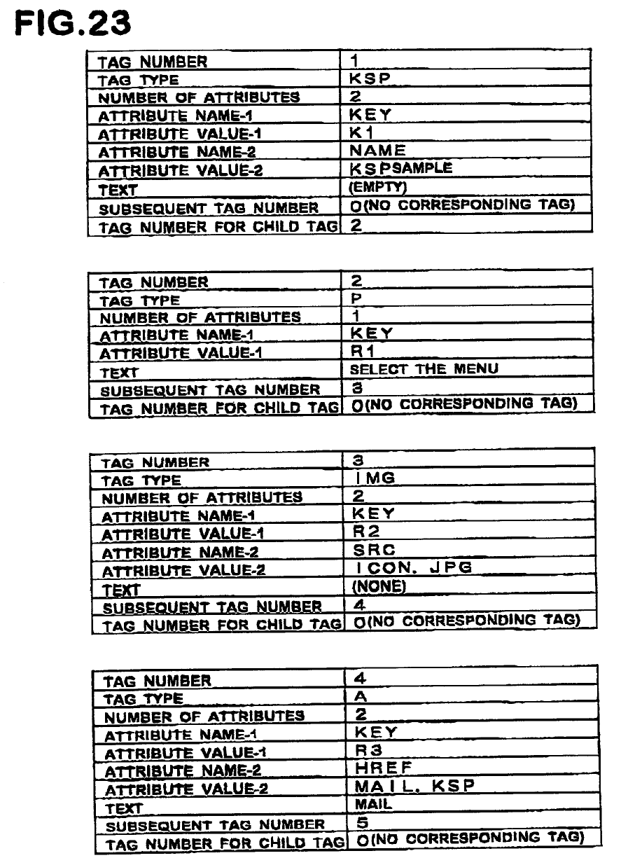

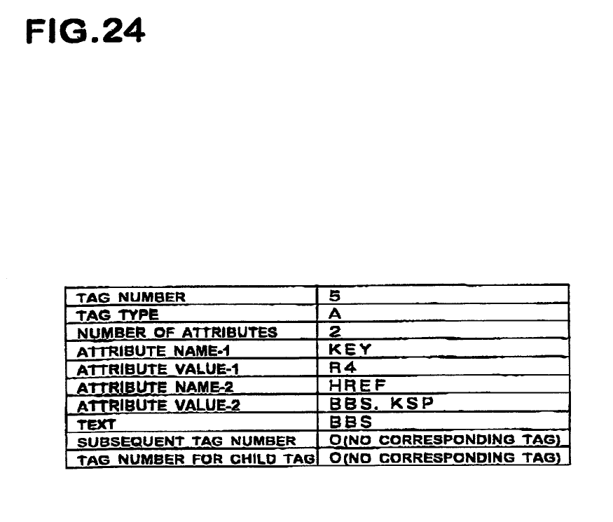

The body depicted in FIG. 6 may express in a tree structure as illustrated in FIG. 21. In the drawing, the numerals within in parentheses indicate tag number. The drawing shows that the entire data of KSP consist of P-tag, IMG-tag, A-tag, and another A-tag. The relationship shown in FIG. 21 may also be expressed as FIG. 22. In other words, the relationship can be expressed using these links, a parent-to-children link indicated in view of parent tag and child-to-child links (brother/sister links) indicated in view of a highly classified child to a lower classified child having the same parent. In this embodiment, the relationship is expressed in a method shown in FIG. 22. It is, therefore, the body depicted in FIG. 6 is converted into data shown in FIGS. 23 and 24 having a tree structure.

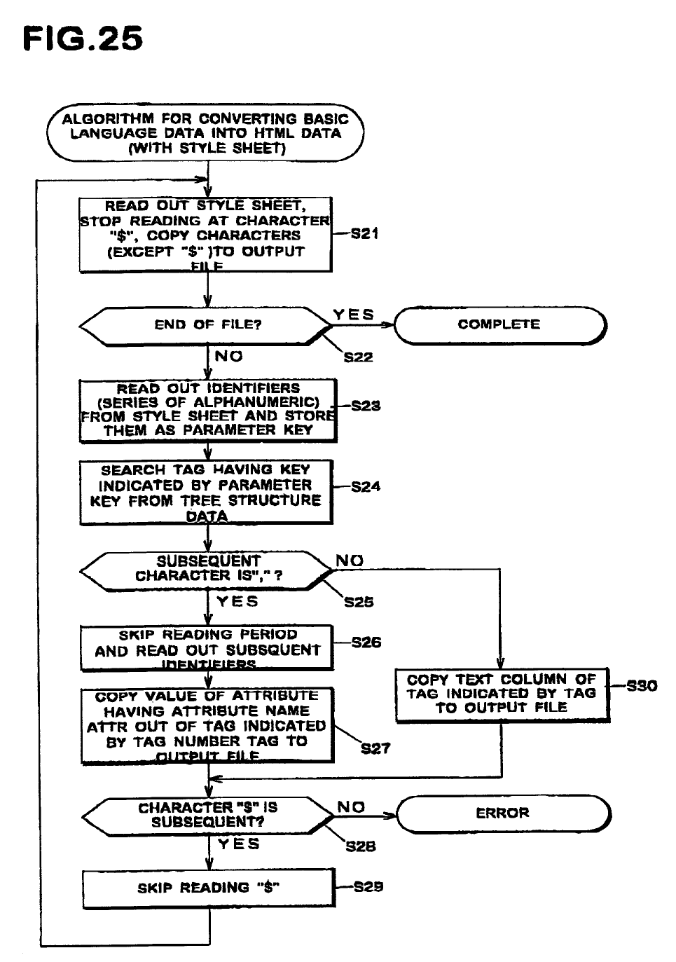

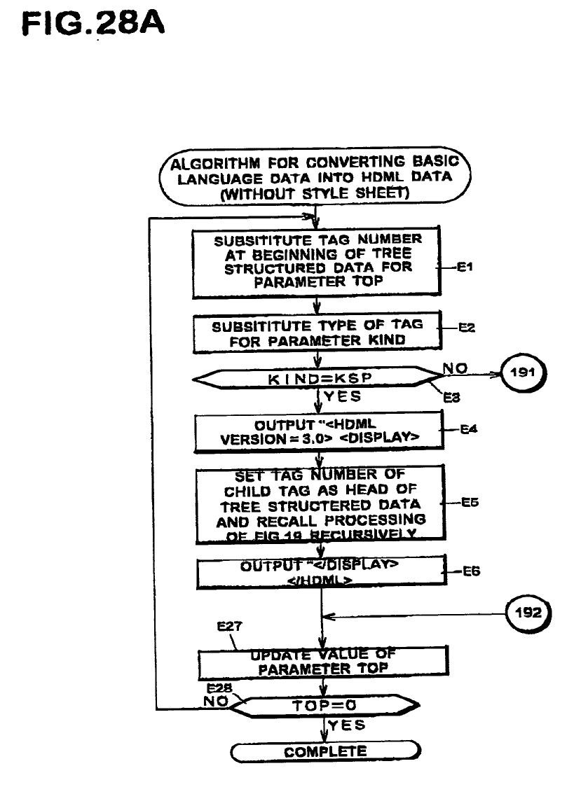

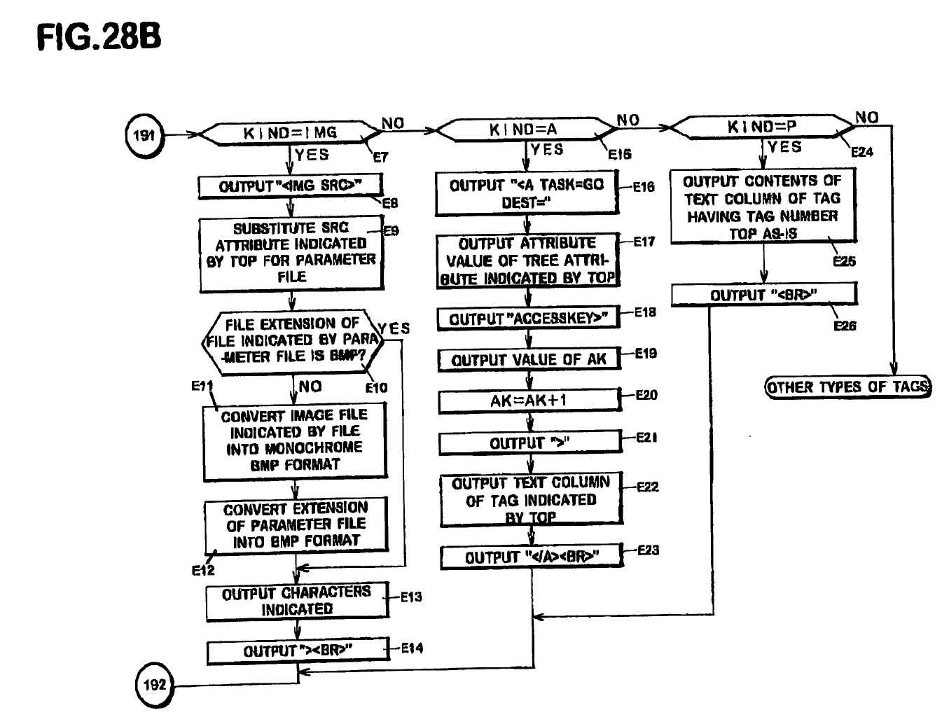

Upon creation of the tree structure data as described above, the original data is converted into data written in the display language using this tree structure data (step S42 of FIG. 19). Flowcharts of such conversion processing are shown in FIGS. 25, 28a and 28b. FIG. 25 shows converting process in which the display language after the conversion accompanies a style sheet and FIGS. 28a, 28b illustrate another conversion process in which the display language after the conversion does not accompany a style sheet.

This description assumes the conversion into HTML data so that the conversion is performed according to a display format described in a style sheet because HTML data always accompanies a style sheet. Therefore, a program for converting basic language data into HTML data shown in FIG. 25 is performed as described below.

Characters in the style sheet depicted in FIG. 7 are read out sequentially and the characters thus read out until the character “$” are copied on an output file (written in HTML) (step S21 of FIG. 25). In the case of using the style sheet depicted in FIG. 7, all the characters “<HTML> line feed <HEAD><TITLE>” are copied on the output file. Subsequently, a judgement whether it is the end of the file (end of the style sheet) (step S22 of FIG. 25). When it reaches to the end of the file, the process ends thereat.

Else, the identifiers (a series of alphanumeric) come subsequent to “$” in the style sheet are read out therefrom. The alphanumeric is stored in the memory 36 as a parameter KEY because the alphanumeric represents a key name assigned to a tag of the basic language data (step S24 of FIG. 25).

Subsequently, the tag having a key indicated by the parameter KEY is searched from the tree structure data shown in FIGS. 23 and 24 and store the tag number thereof into the parameter TAG (step S24 of FIG. 25). Here, the value of the parameter TAG is in 1, because tag number 1 has the key name K1.

Next, another judgement, whether or not the subsequent character on the style sheet is a period, is carried out (step S25 of FIG. 25), if the upcoming character is judged as a period, the content server skip the period from reading, and then identifiers (a series of alphanumeric) subsequent to the period are read out. The alphanumeric thus read out substitutes for a parameter ATTR (step S26 of FIG. 25). Thereafter, the value of an attribute having attribute name ATTR is copied on the output file from a tag indicated by tag number TAG (step S27 of FIG. 25). Here, the attribute name ATTR is equivalent to an identifier NAME because the attribute come after the period is the identifier NAME. Thus, the value of the attribute NAME in the tag number 1 such as “KSP sample” is output on the file.

When a judgement in which the subsequent character is not a period, is made at step S25 of FIG. 25, the text column out of a tag indicated by TAG is copied on the output file (step S30 of FIG. 25).

Subsequently, another judgement, whether or not the subsequent character is “$” is carried out (step S28 of FIG. 25), the content server skip reading it when the subsequent character is “$” (step S29 of FIG. 25), and then the process goes back to step S21. Else, the server judges that an error occurred and ends the process.

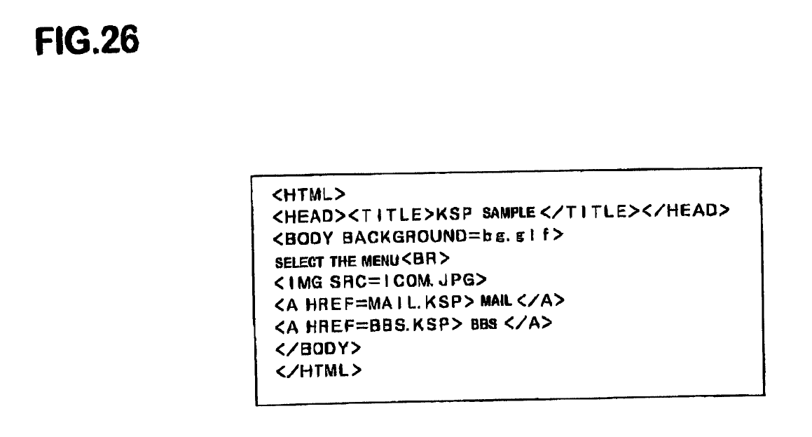

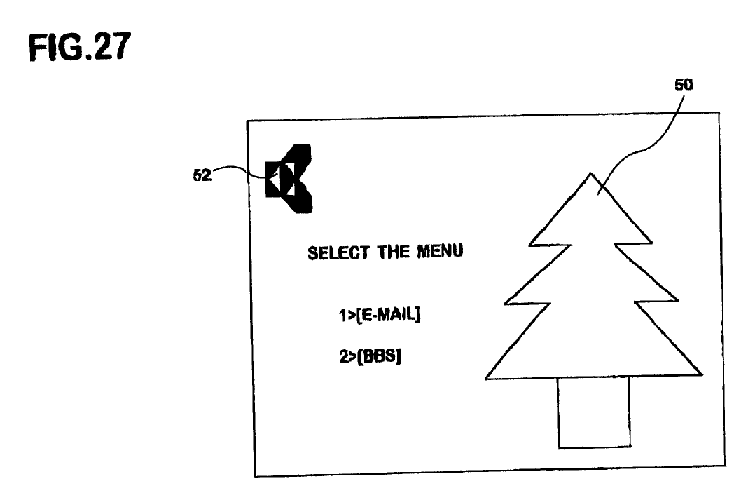

FIG. 26 shows the HTML data thus converted according to the above description. FIG. 27 shows a screen image displayed on the screen of the PC 2 with the HTML data shown in FIG. 26. Wallpaper 50 is displayed with the tag located on the third line. The menu is displayed thereon with the tags located on the fourth, sixth, and seventh lines. It is apparent from the displayed image that images “E-mail”, and “BBS” being underlined are linked in response to tags on the sixth and seventh line. Further, another image 52 is displayed with the tag located on the fifth line.

As described above, the use of a style sheet let the server obtains pure HTML data. In addition, the style sheet allows these in display: decorative work such as creating tables, centering, right-justify, blinking, as well as banner advertising, icons.

Although, data conversion in language from the basic language to HTML has been described in the above description, programs for converting basic language data written into data in other display languages are stored in the server so that a conversion program appropriate to a terminal will automatically selected and used depending on the type of the terminals.

Subsequently, processing performed by the server when a request for viewing a content stored therein is output from the WAP terminal 6 (a mobile phone) will be described. In this case, the algorithm shown in FIG. 10 is also used for identifying the type of a terminal. With this algorithm, it is known that the basic language data need to be converted into HDML data.

Exactly the same processing to the processing described in the above is performed until converting the basic language data into data in a tree structure as shown in FIG. 21. However, the program shown in FIGS. 28a, 28b is executed because no style sheet for HDML data exist in the basic language data illustrated in FIGS. 6 and 7.

In the program, tag number of the tag located at the beginning of the tree structured data shown in FIGS. 23 and 24 is acquired and is substituted for a parameter TOP (step E1 of FIG. 28a). Here, the value of the parameter TOP is equal to 1 because an element located at the beginning thereof is tag number 1. Then, the type of tag indicated by the parameter TOP is fetched and is substituted for a parameter KIND (step E2 of FIG. 28a). Here, it is, therefore, the parameter KIND is equivalent to “KSP”.

Thereafter, the process is branched depending upon contents of the parameter KIND (step E3 of FIG. 28a). Here, the process proceeds to step E4 because the parameter is equal to “KSP”.

At step E4, characters “<HDML VERSION=3.0><line feed><DISPLAY>” are output as header information of HDML on the file. Then, the tag number of a child tag for the TAG number 1 is set as the beginning of the tree structured data, and the processing shown in FIGS. 34a 34b is recalled recursively (step E5 of FIG. 28a). In this case, the parameter TOP comes to 2 at step E1 and the parameter KIND is in “P” at step E2.

Thus, the process proceeds at steps E24 and E25 from step E3 through steps E7, E15. At step E25, contents of the text column of a tag, its tag number being TOP, is output as it is. Here, a text column “select the menu” is output to the file. Subsequently, a tag “<BR>” is output for line feed. (step E26 of FIG. 28b).

Next, the process proceeds to step E27, and the value of a column “subsequent tag number” of the parameter TOP is substituted for the parameter TOP. Here, the value of the parameter TOP is equal to 3. Subsequently, a judgement whether or not the parameter TOP is equal to 0 is carried out (step E28 of FIG. 28b). In this case, the process returns to step E2 because the parameter TOP is not 0.

Thereafter, the type of a tag indicated by the parameter TOP is identified at step E3. In this case, the process proceeds to step E8 from step E7 because the parameter KIND is equivalent to “IMG”. At step E8, an HDML tag indicating images <IMG SRC> is output (step E8 of FIG. 28b). Subsequently, the name of an image file is obtained by using the SRC attribute of a tag indicated by the parameter TOP and the SRC attribute is substituted for a parameter FILE (step E9 of FIG. 28b). In this case, the parameter FILE is equal to “ICON. JPG”. Then, steps following step E11 are executed when the parameter FILE is not “BMP” as a result of carrying out a search for a file extension of a file indicated by the parameter FILE (step E10 of FIG. 28b). On the contrary, the process proceeds to step E13, when the file extension is in “BMP”. In this case, the steps following step E11 of FIG. 28b will be executed because the extension is “JPG” indicating JPEG images, not “BMP”.

Images in “ICON. JPG” are converted into images in a monochrome BMP format at step E11 of FIG. 28b. Next, the extension of the parameter FILE is converted into “BMP” from “JPG” (step E12 of FIG. 28b). It is, therefore, the parameter FILE becomes “ICON. BMP”.

Subsequently, characters indicated by the parameter FILE are output (step E13 of FIG. 28b). Further, an ending tag of the images and a tag for line feed “></BR>” are output (step E14 of FIG. 28b).

Thereafter, the value of the parameter TOP is updated (step E27 of FIG. 28b). In this case, the parameter TOP becomes 4 so that the process proceeds to step E2 through step E28, and the parameter KIND is equal to A thereat. Thus, the process proceeds to step E16 through steps E3, E7 and E15.

At step E16, an HDML tag “A TASK=GO DEST=” representing hyperlink is output to the file (step E16 of FIG. 28b). Subsequently, an HREF attribute of a tag indicated by the parameter TOP is looked over and the value of the attribute is output (step E17 of FIG. 28b). In this case, the value thus output is “MAIL.KSP”.

Next, after a tag “ACCESSKEY=” is output (step E18 of FIG. 28b), the value of a parameter AK is incremented by 1 (step E20 of FIG. 28b). Here, the tag ACCESSKEY is a tag for accelerating operation performed with numeric keypads on the mobile phones, generally a series of numerals used more than one.

Thereafter, the A-tag is finalized by outputting a character “>” (step E21 of FIG. 28b), and the text column of a tag indicated by the parameter TOP is output (step E22 of FIG. 28b). In this case, “mail 1” is written in the text column. Then, the A-tag is closed with characters “</A><BR>” (step E23 of FIG. 28b).

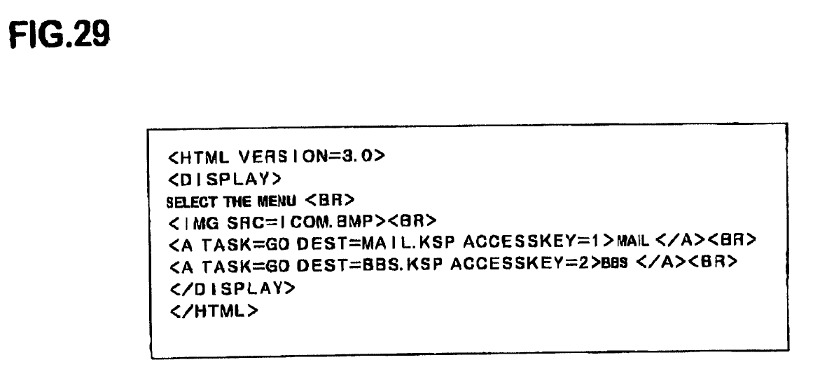

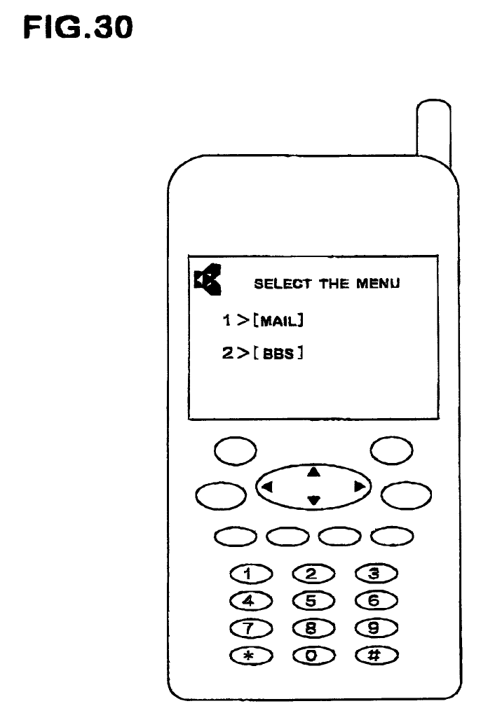

As described above, HDML data, the resultant data of conversion, is obtained as an output file. Thus, conversion of display language into the standard display format is performed when no style sheet for its display language exists in the basic language data. HDML data, the resultant data, is illustrated in FIG. 29. FIG. 30 shows an example of an image of the HDML data displayed on the screen of the WAP terminal 6.

Although, the conversion into HDML data from the basic language data have been described in the above, other programs for language conversion into other display languages are stored in the server so that an appropriate program for conversion is automatically selected and used depending on the type of the terminal accessing the server.

The basic method of converting a language used by an accessing terminal into anther display language employed in the programs is similar to that described in the above. But no function of requiring a link destination is equipped with the terminal when the terminal use a protocol for E-mail and the terminal is used for personal computer communications service. Thus, the current status of the terminal and the link destination after the selection (the transition destination) need to be managed by the server 30. In order to fulfill this requirement, it is necessary for the server not only creating display language data but also managing the status of the terminal, and to create data that can be used for determining the link destination when the link destination is described in the basic language data.

In this embodiment, the conversion is performed on a real time basis whenever the terminal requires it. In this way, update of the content can immediately reflect of the display thereof on the terminal whenever the content is updated

In this embodiment, content data written in the basic language is stored in the server, and the data is converted into display language data written in a language appropriate to the type of a terminal accessing to the server. In this way, content can be viewed on every terminal by just preparing contents written in the basic language.

4. Other Embodiments

(1) Throughout the above embodiments, standardization of contents to may different types of terminal devices is realized. However, the standardization thereof may be applied to a certain type(s) of a terminal device(s). For example, when the server 30 can be viewed by both the i-mode terminal 4 and the PHS terminal 8, a content written in C-HTML is stored in the server 30. The content is transmitted as it is when an access is made by the i-mode terminal 4. Session information is generated and transition is performed according thereto when the PHS terminal 8 accesses to the server 30. In this way, a common content between the i-mode terminal 4 and the PHS terminal 8 can be provided both of them.

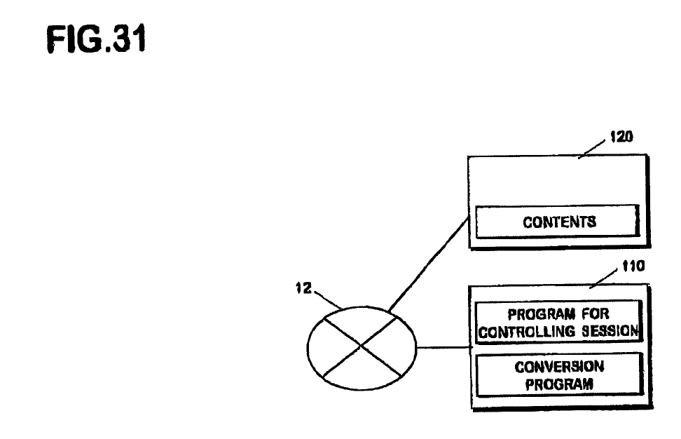

(2) Throughout the above embodiments, generation of session information, control of transition, and conversion in language and format are performed by the content server 30. Alternatively, both a content server 120 storing the content written in the basic language and a converting server 110 storing a program for the conversion and performing conversion processing may be provided independence of each other as shown in FIG. 31.

In order to distribute the load (or providing a backup server) as a result of independently providing the servers, the administrator of the system just provides two of the converting servers 110 so that the administrator is free from preparing two identical contents. In this way, maintenance of the contents can be simplified.

(3) Although, the conversion is performed on a real time basis in the descriptions stated above, content which have been converted according to session information which has previously been generated using the session control program and the program for conversion, may be provided. Alternatively, the conversion may be performed on a real time basis in accordance with the data converted into the tree structure shown in FIGS. 23 and 24, which have been stored in the server.

(4) The type of the terminal (both in hardware and software) accessing is identified by HTTP header in the embodiments described above. Such identification may also be done with its IP address.

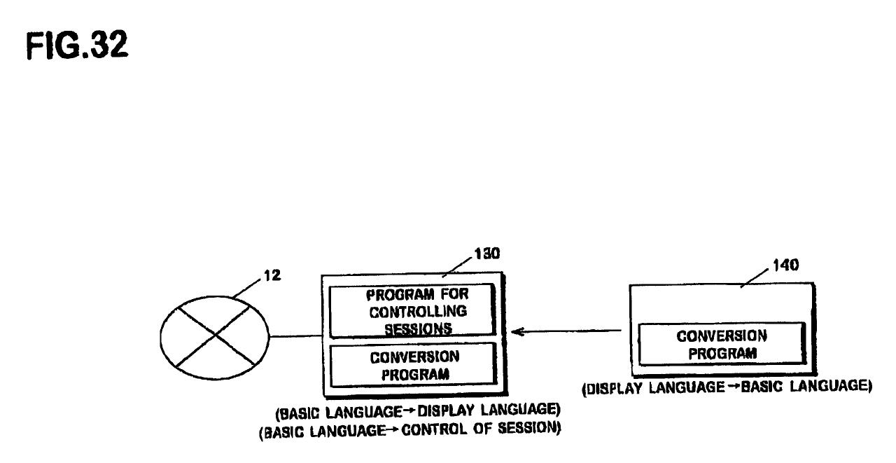

(5) In the embodiments described above, content written in the basic language is stored, and such content is converted into content written in a display language for the terminal. However, the content written in a desired display language can be obtained by performing the processing with a system shown in FIG. 32 in which all the display languages for the terminals are converted once into the basic language using a first converting device 140 storing a first conversion program and then the converted content in the basic language is converted into the content written in the desired language using a second conversion device 130 storing a second conversion program. In this way, contents written in any display language can be viewed on all the terminal devices.

In addition, both the converting devices 130 and 140 may perform the conversion on a real time basis, or they may store the resultant data after performing the conversion thereby.

(6) Displays on the screen have been used as an output format of the content in the embodiments described above, the present invention can also be applied to other output formats such as an audio based output.

While the embodiments of the present invention, as disclosed herein, constitute preferred forms, it is to be understood that each term was used as illustrative and not restrictive, and can be changed within the scope of the claims without departing from the scope and spirit of the invention.

What is claimed is:

1. A content server receiving an access by different types of terminal devices comprising:
content storage means, storing content;
terminal identifying means, identifying whether or not the terminal device accessing thereto is controllable for transition from content to other content in accordance with description in the content received by the accessing terminal device;
management information generating means, generating management information in accordance with content read out from the content storage means when the terminal identifying means judges that the accessing terminal device is not controllable for the transition; and
transition control means, controlling transition of content to be transmitted to the terminal device according to the management information in response to a request from the terminal device.

2. A program for realizing a content server receiving an access by different types of terminal devices with a computer, the content server comprising:
content storage means, storing content;
terminal identifying means, identifying whether or not the terminal device accessing thereto is controllable for transition from content to other content in accordance with description in the content received by the accessing terminal device;
management information generating means, generating management information in accordance with content read out from the content storage means when the terminal identifying means judges that the accessing terminal device is not controllable for the transition; and
transition control means, controlling transition of content to be transmitted to the terminal device according to the management information in response to a request from the terminal device.

3. A storage medium to store the program defined in claim 2.

4. The content server of claim 1 wherein new management information is generated and previous information is discarded whenever the terminal device requires new content.

5. The content server of claim 1 wherein the management information generating means generates non-response permissible information, for terminating communication between the server and the terminal device when no reply is received from the terminal device, as a part of the management information.

6. The content server of claim 1 wherein the management information generating means generates a session ID as a part of the management information whenever the terminal device accesses thereto.

7. The content server of claim 1 wherein the terminal identifying means identifies whether or not the terminal device accessing thereto is controllable for transition by identifying type of the terminal device.

8. The content server of claim 7 wherein the terminal identifying means performs the identification of controllability in accordance with a header of Hyper Text Transfer Protocol (HTTP) sent from the terminal device.

9. The content server of claim 7 wherein the terminal identifying means performs the identification of controllability in accordance with an IP address sent from the terminal device.

10. The content server of claim 1 wherein the terminal identifying means identifies a size of content which can be stored temporarily at the terminal device for its display as well, and wherein the management information generating means divides the content in accordance with its size.

11. A content server receiving an access by different types of terminal devices comprising:
a content storage part for storing content; and
a control part for controlling read out of content from the content storage part and transmission of the content;
wherein the control part identifies whether or not the terminal device accessing thereto is controllable for transition from content to other content in accordance with description in the content received by the accessing terminal device, and generates management information in accordance with the content read out from the content storage part when the control part judges that the accessing terminal device is not controllable for the transition, and controls transition of content to be transmitted to the terminal device according to the management information in response to a request from the terminal device.

12. A program for realizing a content server receiving an access by different types of terminal devices with a computer, the content server comprising:
a content storage part for storing content; and
a control part for controlling read out of content from the content storage part and transmission of the content;
wherein the control part identifies whether or not the terminal device accessing thereto is controllable for transition from content to other content in accordance with description in the content received by the accessing terminal device, and generates management information in accordance with the content read out from the content storage part when the control part judges that the accessing terminal device is not controllable for the transition, and controls transition of content to be transmitted to the terminal device according to the management information in response to a request from the terminal device.

13. A storage medium to store the program defined in claim 12.

14. A content server, wherein the content server temporary generates information for performing transition from content to other content as management information in accordance with description in content received thereby which is written in a self-descriptive language,
and wherein the content server controls transition of content to be transmitted to a terminal device according to the generated management information in response to a request from the terminal device.

15. A program for realizing the following processing by a computer, wherein the content server temporary generates information for performing transition from content to other content as management information in accordance with description in content received thereby which is written in a self-descriptive language,
and wherein the content server controls transition of content to be transmitted to a terminal device according to the generated management information in response to a request from the terminal device.

16. A storage medium to store the program defined in claim 15.

17. The content server of claim 14 wherein the content server divides the content in accordance with a size of content which can be stored temporarily at the terminal device for its display.

18. A method of distributing content to different types of terminal devices, the method comprising the steps of:
storing the content;
identifying whether or not the terminal device requesting content is controllable for transition from content to other content in accordance with description in the content received by the terminal device;
transmitting the requested content with information for controlling the transition contained therein when the requested content is distributed to the terminal controllable for the transition; and
managing transition from content to other content at an end of distributing the content when the requested content is distributed to the terminal uncontrollable for the transition.
